(19) United States
(12) Patent Application Publication
(10) Pub. No.: US 2015/0054770 A1
(43) Pub. Date: Feb. 26, 2015

(54) DRIVING DEVICE, ELECTRONIC DEVICE, AND DRIVE CONTROL PROGRAM

(71) Applicant: FUJITSU LIMITED, Kawasaki-shi (JP)

(72) Inventors: KIYOSHI TANINAKA, Ebina (JP); Yuichi Kamata, Isehara (JP); Yasuhiro Endo, Ebina (JP); Akihiko Yabuki, Isehara (JP)

(73) Assignee: FUJITSU LIMITED, Kawasaki (JP)

(21) Appl. No.: 14/532,447

(22) Filed: Nov. 4, 2014

Related U.S. Application Data
(63) Continuation of application No. PCT/JP2012/064953, filed on Jun. 11, 2012.

(51) Int. Cl. G06F 3/041; G06F 3/01

(52) U.S. Cl. CPC G06F 3/0416; G06F 3/016
USPC 345/173

(57) ABSTRACT

A driving device includes a storage unit configured to store waveform data of driving signals of a sinusoidal wave satisfying a frequency f1=m/n×f0 (m, n are natural numbers and m≠n) where a resonance frequency of an actuator is f0, wherein the driving signals excite the actuator for an m number of times; and a processor programmed to execute a process including reading the waveform data stored in the storage unit and outputting, to the actuator, the driving signals corresponding to the waveform data that has been read.

### CROSS-REFERENCE TO RELATED APPLICATION

This application is a U.S. continuation application filed under 35 USC 111(a) claiming benefit under 35 USC 120 and 365(c) of PCT Application PCT/ JP2 012 /0 64 953 filed, on Jun. 11, 2012, the entire contents of which are incorporated herein by reference.

### FIELD

The embodiments discussed herein are related to a driving device, an electronic device, and a drive control program for driving an actuator.

### BACKGROUND

Conventionally, there is an electronic device including a flat touch panel as an input unit. The touch panel is for receiving a touch to the touch panel as an input, operation, and no considerations have been made for providing a tactile sensation in accordance with the operation. Therefore, in a conventional touch panel, there has been demand for installing a device for expressing a tactile sensation in accordance with an operation.

Thus, in recent years, for example, considerations have been made to provide a tactile sensation in accordance with an operation by using the vibration caused by a LRA (Linear Resonant Actuator). Furthermore, as the driving method of a LRA, there is an example described in Patent Document 1, and an exclusive-use IC (Integrated Circuit) for controlling a tactile presentation device.

Patent Document 1: Japanese Laid-Open Patent Publication No. 2012-20284

However, in the case of a vibration using LRA, the vibration does not immediately stop when the input is stopped. Therefore, for example, it is difficult to express a precipitous tactile sensation caused by an operation of pressing a button of a metal dome type. Furthermore, Patent Document 1 describes a vibration suppressing unit for performing antiphase input after the input of the LRA is stopped; however, the suppression effects have been insufficient. Therefore, by the conventional technology, it has been difficult to appropriately express the differences in tactile sensations in accordance with different types of operations.

### SUMMARY

According to an aspect of the embodiments, a driving device includes a storage unit configured to store waveform data of driving signals of a sinusoidal wave satisfying a frequency f1=m/n×f0 (m, n are natural numbers, and m≠n) where a resonance frequency of an actuator is f0, wherein the driving signals excite the actuator for an m number of times; and a processor programmed to execute a process including reading the waveform data stored in the storage unit and outputting, to the actuator, the driving signals corresponding to the waveform data that has been read.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIGS. 1A and 1B illustrate an overview of a first embodiment;

FIG. 2 illustrates the sensitivity of a human's organ for feeling acceleration;

FIG. 3 illustrates an electronic device according to the first embodiment;

FIGS. 4A and 4B illustrate examples of LRAs;

FIG. 5 illustrates a driving device according to the first embodiment;

FIG. 6 is a flowchart illustrating the driving of the LRA performed by the driving device according to the first embodiment;

FIG. 7 is a pattern diagram of an example of the LRA;

FIG. 8 illustrates an example of driving signals of the LRA according to the first embodiment;

FIGS. 9A and 9B illustrate the displacement, of the LRA;

FIGS. 10A through 10C illustrate examples of the speed of the vibration and the acceleration of the vibration of the LRA;

FIGS. 11A through 11C illustrate the acceleration of the vibration of the LRA, when the sinusoidal wave of the natural vibration frequency of the LRA is used as the driving signals;

FIGS. 12A and 12B illustrate the acceleration, of the vibration of the LRA, when the voltage of the antiphase of the vibration generated in the LRA is applied as vibration suppression signals, after the stop of the driving signals according to the sinusoidal wave of the natural vibration frequency of the LRA;

FIGS. 13A through 13C illustrate the acceleration of the vibration of the IRA when signals that do not satisfy the particular condition are used as the driving signals;

FIGS. 14A through 14C illustrate the acceleration of the vibration of the IRA when signals that satisfy the particular condition are used as the driving signals;

FIG. 15 illustrates an example of an electronic device in which the LRA is provided in a case;

FIG. 16 illustrates a driving device according to a second embodiment; and

FIG. 17 is a flowchart of a process of measuring the resonance frequency according to the second embodiment.

### DESCRIPTION OF EMBODIMENTS

### First Embodiment

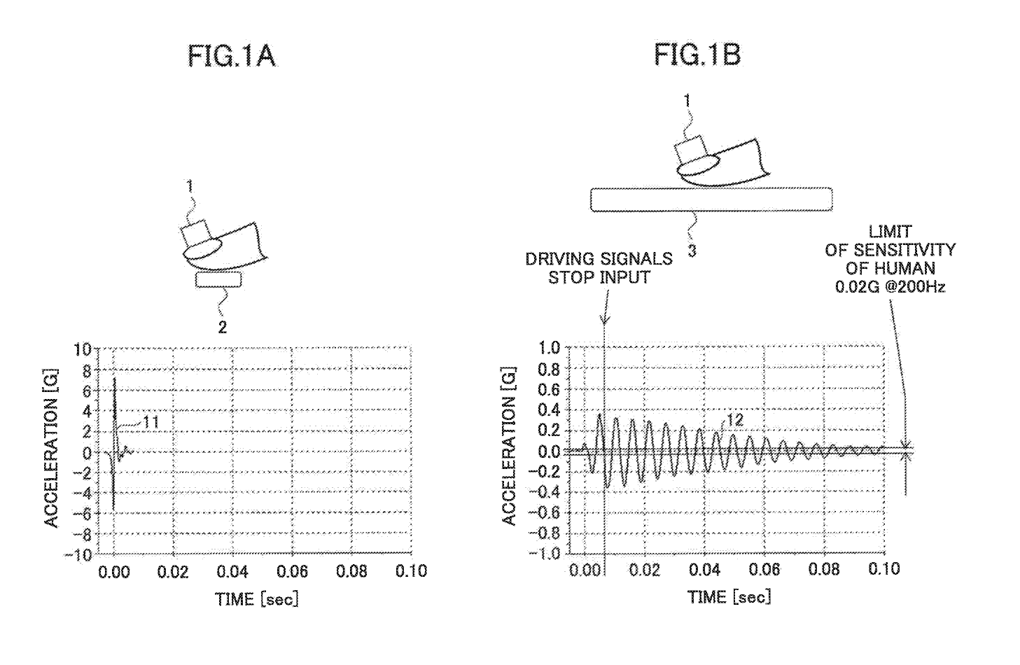

An overview of the present embodiment is described below with reference to FIGS. 1A and 1B. FIGS. 1A and 1E illustrate an overview of a first embodiment.

FIG. 1A illustrates a waveform 11 of acceleration of a vibration that is generated when a button 2 is pressed by a human being's finger to which an acceleration meter 1 is attached. FIG. 1B illustrates a waveform 12 of acceleration of a vibration that is generated when a touch panel 3 to which a LRA (Linear Resonant Actuator) is attached, is touched by a human being's finger to which an acceleration meter 1 is attached. In the example of FIG. 1A, the button 2 is, for example, a button of a metal dome type. Furthermore, the button 2 and the touch panel 3 are provided in an electronic device.

The vibration indicated by the waveform 11 rapidly attenuates in one through several cycles. Meanwhile, the vibration indicated by the waveform 12 continues until, the free vibration according to the natural vibration frequency of LRA attenuates, even after the supply of driving signals is stopped. In the following description of the present embodiment, the free vibration according to the natural vibration frequency of the LRA, which continues after supply of driving signals is stopped., is referred to as a residual vibration.

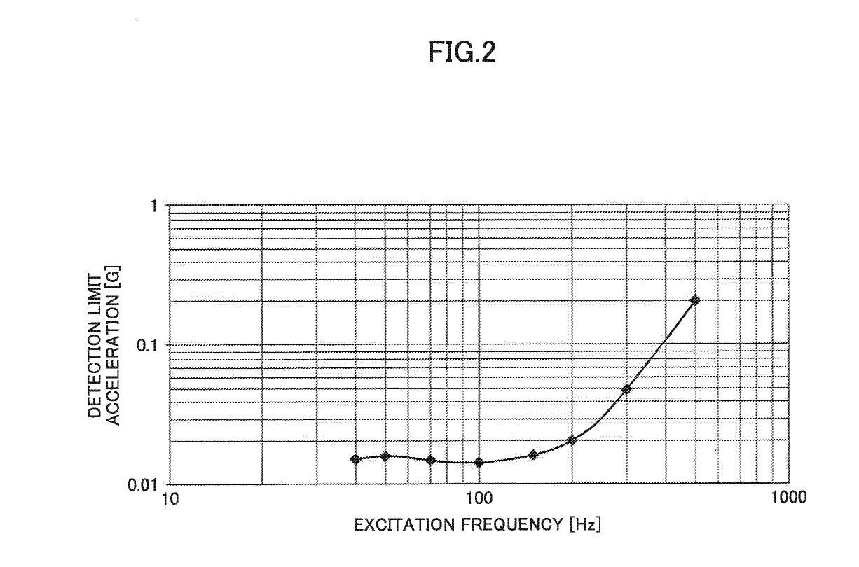

Incidentally, the human fingertip becomes incapable of feeling a vibration, when the acceleration of the vibration becomes less than or equal to 0.02 G in a vibration frequency 200 Hz. The vibration frequency is the number of vibrations per second. The acceleration of the vibration indicates the amount of change in velocity of the vibration per unit, time, FIG. 2 illustrates the sensitivity of a human's organ for feeling acceleration. Note that the human's organ, for feeling acceleration is the Pacinian corpuscle. The Pacinian corpuscle is one of the four major types of mechanoreceptor mainly found in the skin.

That is to say, with respect to the waveform 11, the finger stops feeling the vibration within 0.01 seconds because the acceleration of vibration becomes less than or equal to 0.02 G. Meanwhile, with respect to the waveform 12, it takes 0.1 second for the acceleration of vibration to become less than or equal to 0.02 G, and therefore the finger continues to feel the vibration until 0.1 second passes. Therefore, the human feels completely different tactile sensations in the case of the vibration indicated by the waveform 11 and in the case of the vibration indicated by the waveform 12.

Thus, in the present embodiment, by suppressing the residual vibration, a vibration that rapidly attenuates in one through several cycles is generated, to express a clicking feeling.

In the present embodiment, attention is focused on the fact that when driving signals satisfying a particular condition are supplied to the LRA 140, the vibration of the LRA 140 stops in one through several cycles and a residual vibration is not generated, and therefore driving signals satisfying this particular condition are applied to the LRA 140.

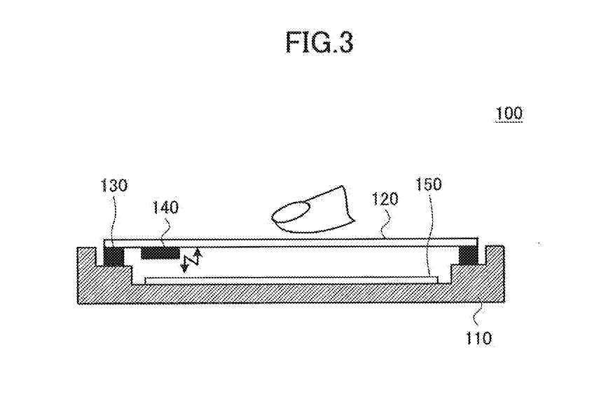

In the following, a description is given of an electronic device according to the present embodiment with reference to FIG. 3. FIG. 3 illustrates an electronic device according to the first embodiment.

The electronic device according to the present embodiment may be any device having a touch panel including, for example, a display function and an input function, as an input unit. For example, the electronic device according to the present embodiment may be a smartphone, a tablet type computer, or a mobile information terminal.

An electronic device 100 according to the present embodiment, includes a case 110, a touch panel 120, a double-sided tape 130, a LRA 140, and a substrate 150.

In the electronic device 100 according to the present embodiment, the touch panel 120 is fixed to the case 110 by the double-sided tape 130. The LRA 140 is attached to the surface of the touch panel 120 on the side of the case 110. The LRA 140 is formed by combining a vibration system having a resonance frequency designed in advance and an actuator. The LRA 140 is a vibration device for generating a vibration mainly by driving the actuator with the resonance frequency, in which the intensity of vibration changes according to the amplitude of the driving waveform. Details of the LRA 140 are described below. Note that in the present embodiment, the LRA 140 is the vibration device; however, the vibration device is not limited to a LRA as long as the vibration device has a structure including a resonator and an actuator to be subjected to excitation.

The substrate 150 is arranged inside the case 110. On the substrate 150, a driving device for controlling the driving of the LRA 140 and a driver IC for outputting driving signals to the LRA 140, are mounted.

When the user's finger contacts the touch panel 120, the electronic device 100 according to the present embodiment detects this contact and drives the LRA 140 by the driving device mounted on the substrate 150 and propagates the vibration of the LRA 140 to the touch panel 120.

Note that the electronic device 100 according to the present embodiment may be any device including the touch panel 120 as an input operation unit, and may therefore be a device such as an ATM (Automatic Teller Machine) that is installed and used at a particular location.

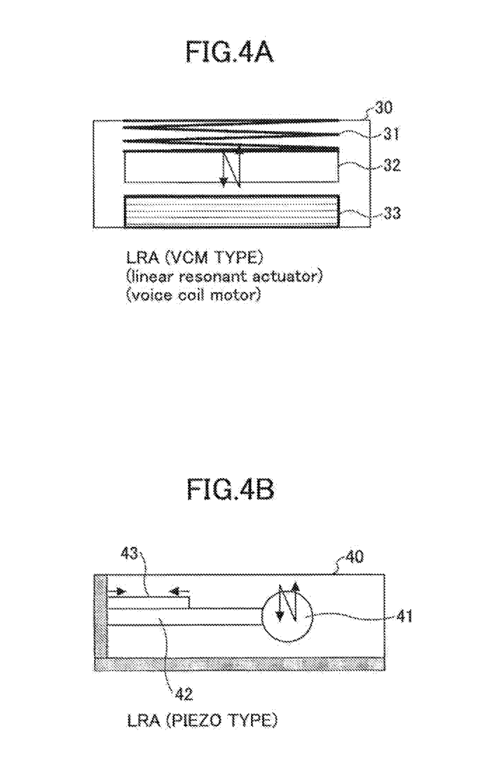

In the following, a description is given of the LRA 140 with reference to FIGS. 4A and 4B. FIGS. 4A and 4E illustrate examples of LRAs. FIG. 4A illustrates an example of a LRA using a voice coil, and FIG. 4B illustrates an example of a LRA using a piezoelectric element.

A LRA 30 illustrated in FIG. 4A includes a spring 31, a magnet 32, and a coil 33. With respect to the LRA 30, the natural vibration frequency f0 is indicated by the following formula 1, where the spring constant of the spring 31 is k, and the mass of the magnet 32 is in.

$${f}_{0} = \frac{1}{2 π} \sqrt{\frac{k}{m}} \qquad Formula 1$$

A LRA 40 illustrated in FIG. 4B includes a weight 41, a beam 42, and a piezoelectric element 43. With respect to the LRA 40, a natural vibration frequency f0 is indicated by the following formula 2, where the mass of the weight 41 is m, the Young's modulus of the beam 42 is E, the cross-sectional second moment of the beam 42 is I, and the length in the longitudinal direction of the beam 42 is L.

$${f}_{0} \approx \frac{1}{2 π} \sqrt{\frac{3 E I}{m {L}^{3}}} \qquad Formula 2$$

As the LRA 140 according to the present embodiment, the LRA 30 using a voice coil may be applied, or the LRA 40 using the piezoelectric element 43 may be applied.

Next, with reference to FIG. 5, a description is given of the driving device mounted or the substrate 150 included in the electronic device 100 according to the present embodiment. FIG. 5 illustrates the driving device according to the first embodiment.

A driving device 200 according to the present embodiment includes a CPU (Central Processing Unit) 210 and a memory 220. The CPU 210 performs a process of driving the LRA 140 described below, by reading and executing a drive control program 230 stored in the memory 220. The memory 220 is provided with a storage area storing the drive control program 230 for controlling the driving of the LRA 140, a storage area storing waveform data 240, and a storage area storing an API (Application Programming Interface) 250 for providing a tactile sensation.

The drive control program 230 causes the CPU 210 to execute drive control of the LRA 140. The waveform data 240 is data expressing the driving waveform generated in advance for expressing a clicking feeling by a vibration generated by the LRA 140. Details of the waveform data 240 are described below. The API 250 is activated by the drive control program 230, and performs various processes for providing a tactile sensation. In FIG. 5, the API 250 is stored in the memory 220; however, the API 250 may be stored in another memory mounted or the substrate 150.

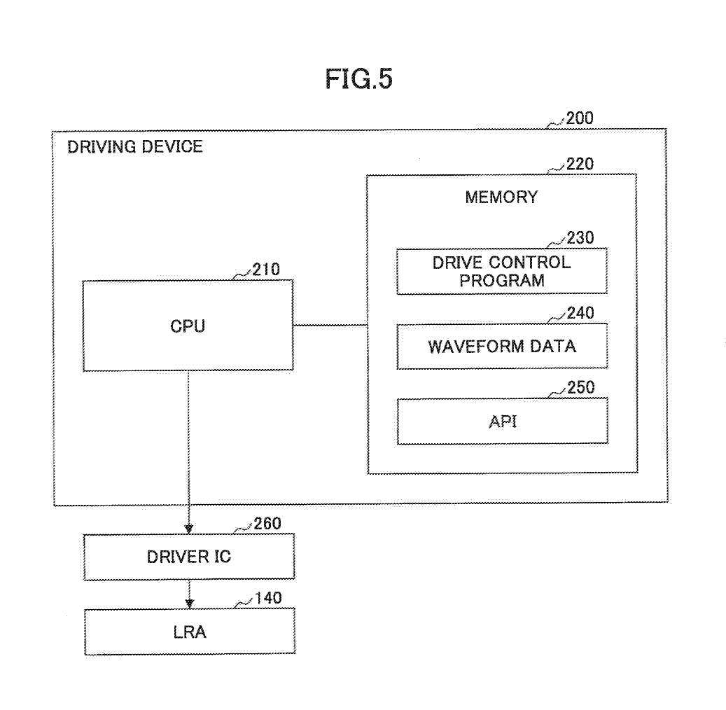

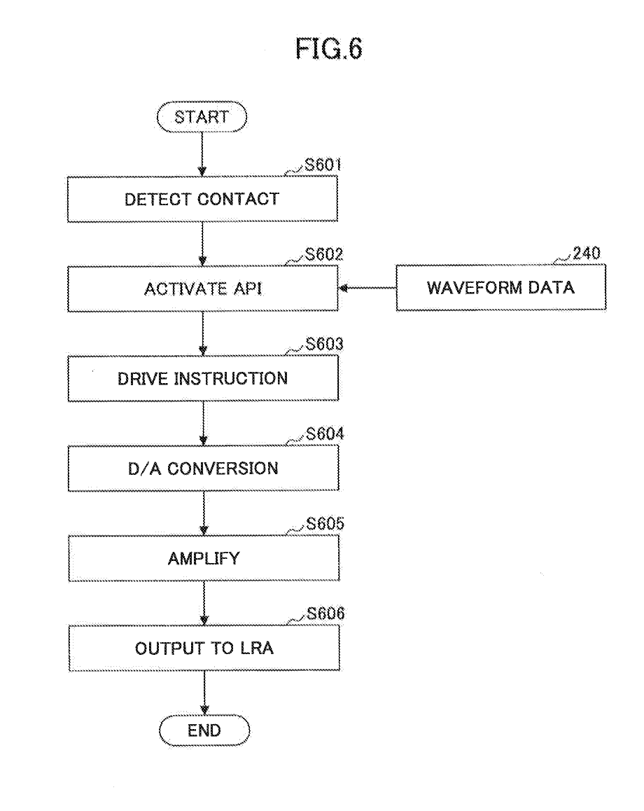

FIG. 6 is a flowchart illustrating the driving of the LRA 140 performed by the driving device 200 according to the first embodiment.

When the driving device 200 according to the present embodiment detects a contact made with the touch panel 120 (step S601), the driving device 200 activates the API 250 (step S602). Specifically, for example, the driving device 200 may activate the API 250 when a contact is made with a button displayed on the touch panel 120.

The API 250 reads the waveform data 240 stored in the memory 220, and outputs a drive instruction corresponding to the waveform data 240, to a driver IC 260 (step S603). The driver IC 260 receives the drive instruction and performs D/A (Digital to Analog) conversion on the waveform data 240 (step S604), and amplifies the waveform data 240 by an amplifier (step S605). The driver IC 260 outputs the amplified signals to the LRA 140 (step S606).

In the following, a description is given of the waveform data 240 according to the present embodiment. The waveform data 240 according to the present embodiment is data indicating the waveform of driving signals satisfying a particular condition for stopping the residual vibration.

The driving signals satisfying a particular condition are signals of a frequency f1 of f1=m/n×f0 (m, n are natural numbers, and m=n) for exciting the LRA 140 for an m number of times, where the natural vibration frequency of the LRA 140 (hereinafter, “resonance frequency”) is f0.

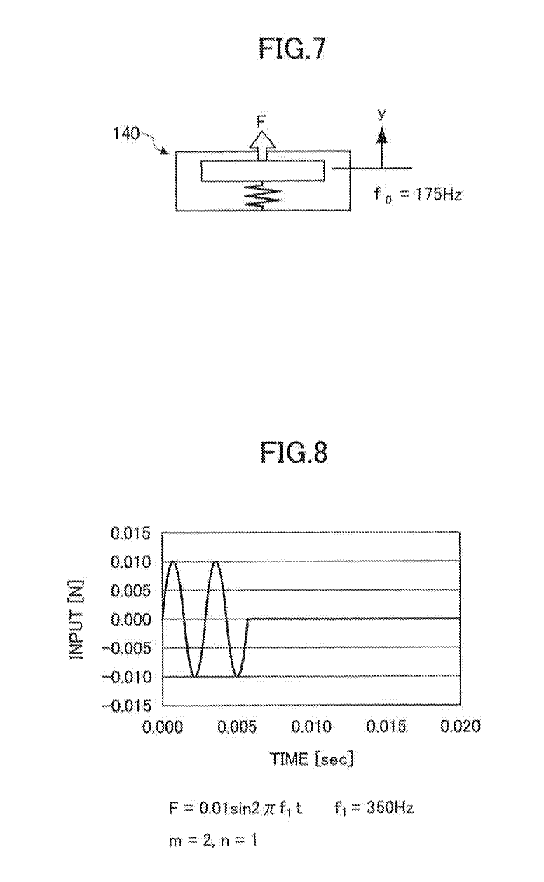

FIG. 7 is a pattern diagram of an example of the LRA 140 according to the first embodiment, and FIG. 8 illustrates an example of driving signals of the LRA 140 according to the first embodiment.

In the LRA 140 according to the present embodiment, as illustrated in FIG. 7, the resonance frequency is f0=175 Hz, the weight of tine weight is 1.5 g, and the spring constant supporting the weight is 1813.5 N/m.

The driving signals according to the present embodiment have the frequency f1=2/1×175=350 Hz where m=2, n=1, When the frequency is f1, the driving signals F form a waveform as illustrated in FIG. 8. In the example of FIG. 8, the driving signals are F=0.01sin2πf1t. The driving signals F of FIG. 8 form a sinusoidal wave of two cycles because m=2.

In the present embodiment, for example, the data indicating the driving signals F illustrated in FIG. 8 are stored in the memory 220 as the waveform data 240. The waveform data 240 may include, for example, the value of the frequency f1 of the driving signals F, the values of the amplitude and. the phase, and the values of m, n. Furthermore, the waveform data 240 may be data indicating the waveform itself of the driving signals F.

Furthermore, in the present embodiment, the frequency f1 of the driving signals F is preferably set such that the error with respect to m/n×f0 is less than or equal to 1%. By setting the frequency f1 in this manner, even when a residual vibration occurs after stopping applying the driving signals, the acceleration of the vibration is less than or equal to 0.02 G which is the lower limit of perception by a human being, such that the residual vibration is not perceived by a human being, and therefore the clicking feeling is not lost.

In step S603 of FIG. 6, the driving device 200 according to the present embodiment, reads the waveform data 240 indicating the driving signals F by the API 250, and outputs a driving instruction corresponding to the waveform data 240, to the driver IC 260. The driver IC 260 performs D/A conversion on the waveform data 240 and amplifies the waveform data 240, and outputs the waveform data 240 to the LRA 140.

A description is given of a case where the driving signals F are applied to the LRA 140, in the driving device 200 according to the present embodiment.

When the driving signals F are applied to the IRA 140, a forced vibration of the frequency f1 and a free vibration of the resonance frequency f0 of the LRA 140 are generated, in the LRA 140, and the displacement of the LRA 140 corresponds to a synthetic wave of these vibrations.

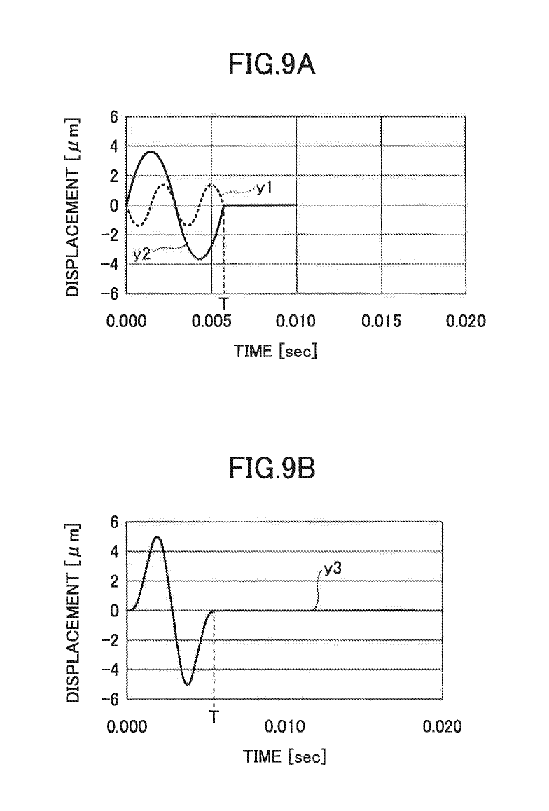

FIGS. 9A and 9B illustrate the displacement of the LRA 140. FIG. 9A is a first diagram illustrating the displacement, and FIG. 9B is a second diagram illustrating the displacement.

In FIG. 9A, the waveform illustrated by the dotted line indicates a forced vibration component y1 of the vibration displacement that occurs when the driving signals F are applied to the LRA 140, and the waveform illustrated by the solid line indicates a free vibration component y2. The response displacement y3 when the driving signals F are applied, to the LRA 140 is a synthetic wave of the forced vibration component y1 and the free vibration component y2.

FIG. 9B illustrates an example of the response displacement y3. As seen in FIG. 9B, the response displacement y3 becomes zero at a timing T at which the driving signals F become zero.

At the timing T when the response displacement y3 becomes zero, the speed of the vibration and the acceleration of the vibration of the LRA 140 both become zero, and therefore the vibration of the LRA 140 stops.

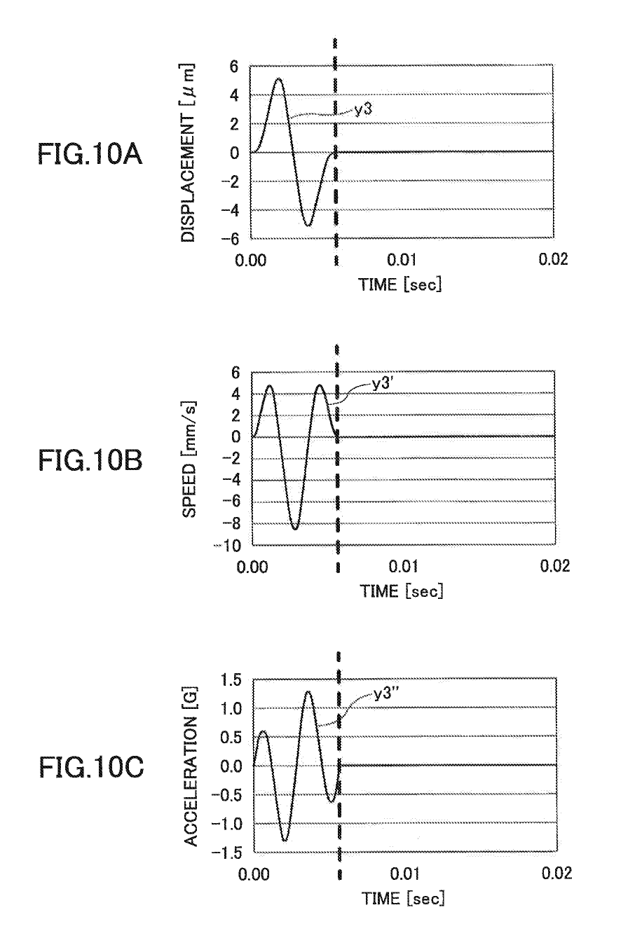

FIGS. 10A through 10C illustrate examples of the. speed of the vibration and the acceleration of the vibration of the LRA 140. FIG. 10A illustrates a waveform of a response displacement y3, FIG. 10B illustrates a waveform of a speed waveform y3′ that is the first derivative of the response displacement y3, and FIG. 10C illustrates a waveform of an acceleration waveform y3″ that is the second derivative of the response displacement y3.

As seen in the example of FIGS. 10A through 10C, the speed waveform y3′ and the acceleration waveform y3″ become zero at the timing when the response displacement y3 becomes zero. That is to say, the vibration of the LRA 140 stops at the timing T.

At this time, the acceleration waveform y3″ stops at two cycles within 0.01 sec. Therefore, in the example of FIGS. 10A through 10C, the acceleration of the vibration becomes less than or equal to 0.02 G within 0.01 sec, and it is possible to express a clicking feeling when the button 2 is pressed.

Note that in the present embodiment, m=2 and n=1; however, the present embodiment is not so limited. In the present embodiment, any value is applicable as long as the conditions that m, n are natural numbers, and m≠n, are satisfied. Note that the relationship of m and n preferably satisfies m<n.

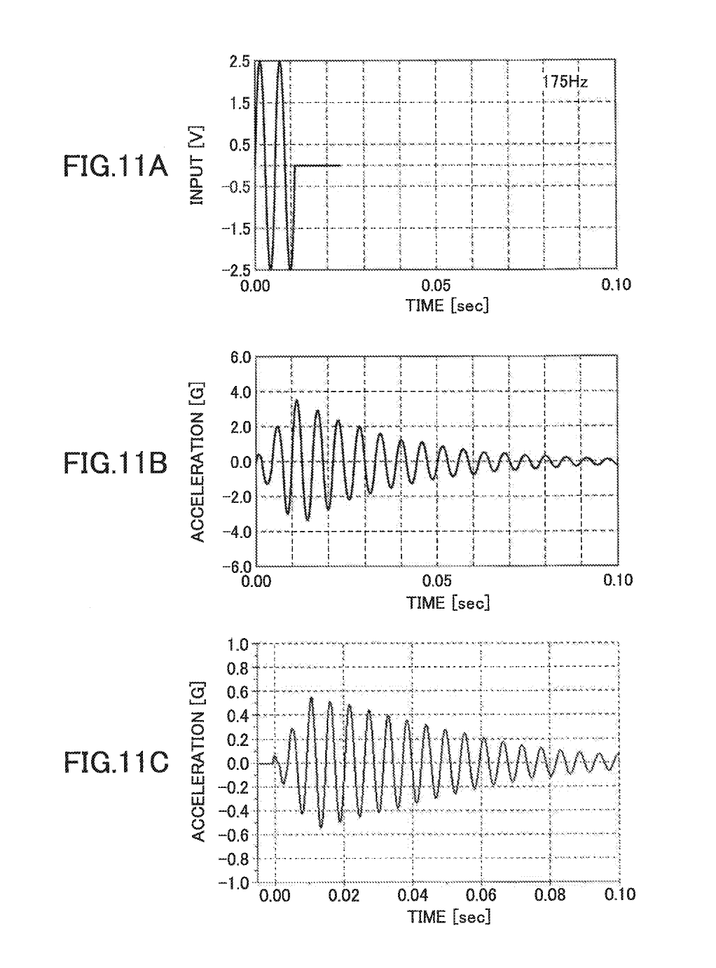

In the following, with reference to FIGS. 11A through 14C, a description is given of effects of the present embodiment. FIGS. 11A through 11C illustrate the acceleration of the vibration of the LRA 140, when the sinusoidal wave of the resonance frequency of the LRA 140 is used as the driving signals.

FIG. 11A illustrates driving signals of the sinusoidal wave of the resonance frequency f0=175 Hz of the LRA 140. FIG. 11B illustrates the acceleration of the vibration of the LRA 140 when simulation is performed by using the sinusoidal wave of FIG. 11A as driving signals. FIG. 11C illustrates the acceleration of the vibration of the touch panel 120 when driving signals of FIG. 11A are applied to the LRA 140 in an actual machine in which the LRA 140 having a resonance frequency f0=175 Hz is installed. Note that the acceleration of the touch panel 120 is detected by arranging an acceleration meter at the center of the touch panel 120.

As seen in the examples of FIGS. 11B and 11C, when the sinusoidal wave of the resonance frequency f0 is used as the driving signals, the residual vibration occurs for more than 0.1 sec,

Note that in FIG. 11C, in the LRA 140 to which the driving signals are applied, the resonance frequency is f0=175 Hz, the weight of the weight is 1.5 g, and the spring constant, supporting the weight, is 1813.5 N/m.

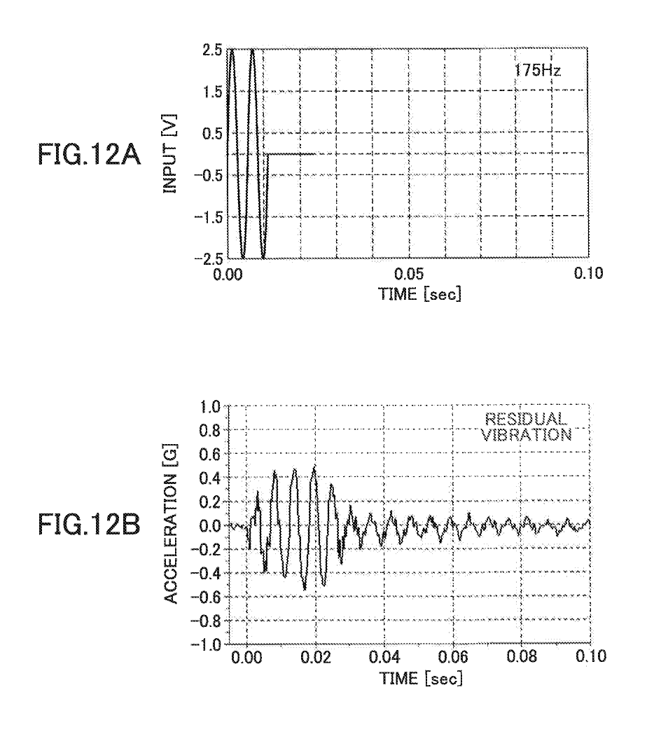

FIGS. 12A and 123 illustrate the acceleration of the vibration of the LRA 140, when the voltage of the antiphase of the vibration generated in the LRA 140 is used as vibration suppression signals applied, to the LRA 140, by a driving instruction. FIG. 12A illustrates driving signals of the sinusoidal wave of the resonance frequency f0=175 Hz of the LRA 140. FIG. 12B illustrates the acceleration of the vibration of the touch panel 120 in an actual machine in which the LRA 140 is installed, when the sinusoidal wave of FIG. 12A is used as driving signals and a voltage, which is of an antiphase of the vibration that occurs in the LRA 140 after the supply of the driving signals is stopped, is applied.

In the example of FIGS. 12A and 12B, the residual, voltage is less than that of FIGS. 11A through 11C; however, it takes more than 0.05 sec until the acceleration of the vibration becomes less than or equal to 0.02 G which is the lower limit of perception by a human being.

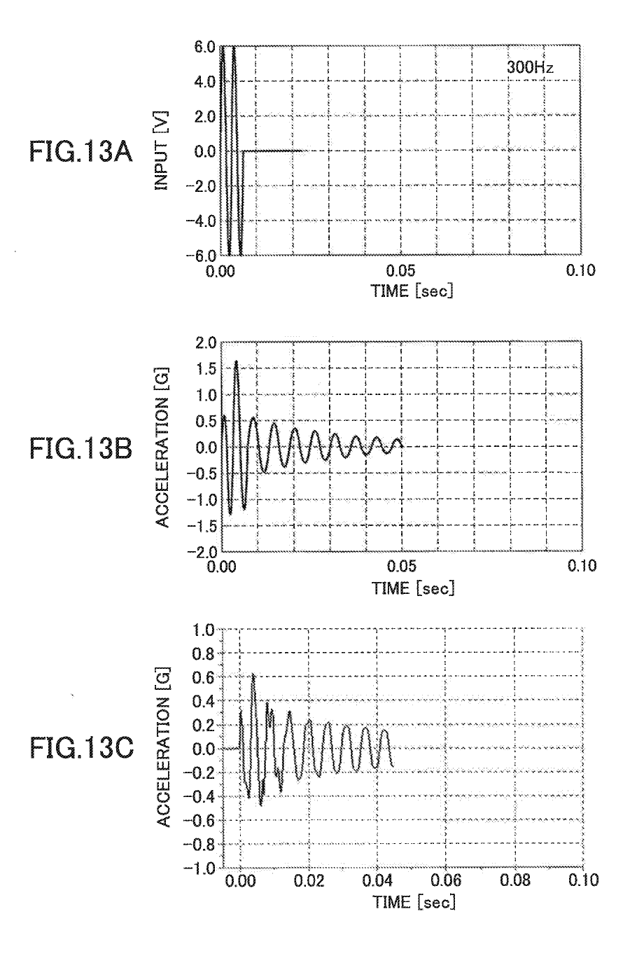

FIGS. 13A through 13C illustrate the acceleration of the vibration of the LRA 140 when signals that do not satisfy the particular condition are used as the driving signals.

FIG. 13A illustrates driving signals of the sinusoidal wave of a frequency 300 Hz that does not satisfy the particular condition. FIG. 13B illustrates the acceleration of the vibration of the LRA 140 when simulation is performed by using the sinusoidal wave of FIG. 13A as driving signals. FIG. 13C illustrates the acceleration of the vibration of the touch panel 120 when driving signals of FIG. 13A are applied to the LRA 140 in an actual machine in which the LRA 140 having a resonance frequency f0=175 Hz is installed,

As seen in the examples of FIGS. 13B and 13C, when the sinusoidal wave of the frequency that does not satisfy the particular condition is used as the driving signals, the residual vibration occurs for more than 0.04 sec.

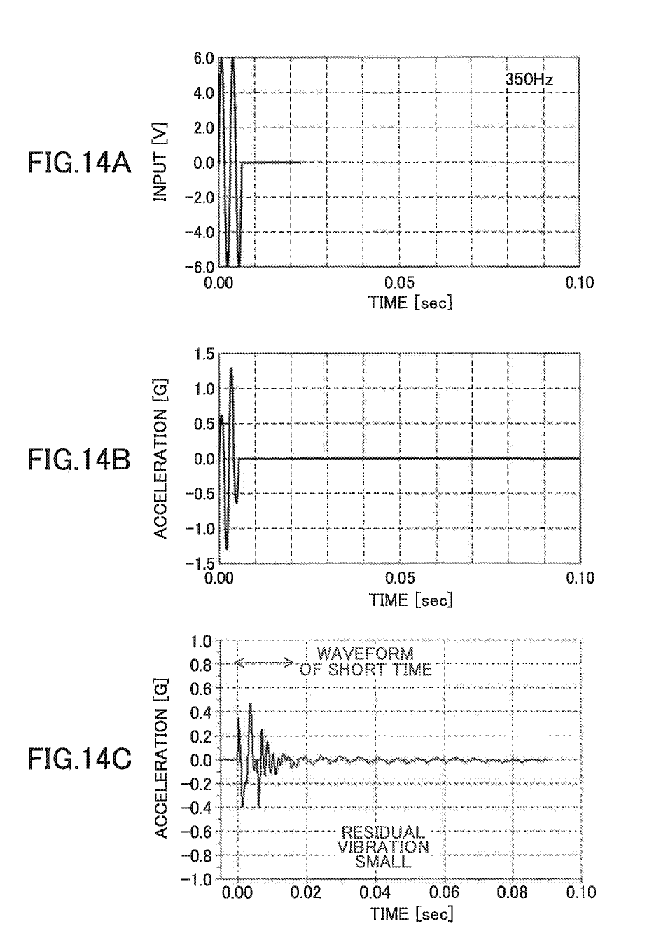

FIGS. 14A through 14C illustrate the acceleration of the vibration of the LRA 140 when signals that satisfy the particular condition are used as the driving signals.

FIG. 14A illustrates driving signals of the sinusoidal wave of a frequency 350 Hz that satisfies the particular condition. FIG. 14B illustrates the acceleration of the vibration of the LRA 140 when simulation is performed by using the sinusoidal wave of FIG. 14A as driving signals. FIG. 14C illustrates the acceleration of the vibration of the touch panel 120 when driving signals of FIG. 14A are applied to the LRA 140 in an actual machine in which the LRA 140 having a resonance frequency f0=175 Hz is installed.

As seen in the examples of FIGS. 14B and 14C, after the passage of 0.02 sec, the acceleration of the residual vibration becomes less than or equal to 0.02 G which is the lower limit of perception, and the waveform of the vibration becomes a waveform of a short time.

According to the above, in the waveform of the vibration according to the LRA 140, when the resonance frequency of the LRA 140 is f0, and signals of a frequency f1 of f1=m/n×f0 (m, n are natural numbers, and m≠n) are used as driving signals for exciting the LRA 140 for an m number of times, it is possible to eliminate a residual vibration. Furthermore, the waveform of the acceleration of the vibration of the touch panel 120 in an actual machine in which the LRA 140 is installed, becomes a waveform of a short time that rapidly attenuates in one through several cycles, and therefore a clicking feeling is expressed.

Furthermore, in the electronic device 100 according to the present embodiment, the LRA 140 is attached to the surface of the touch panel 120 on the side of the case; however, the present embodiment is not so limited. For example, the LRA 140 may be arranged near the substrate 150 arranged inside the case 110.

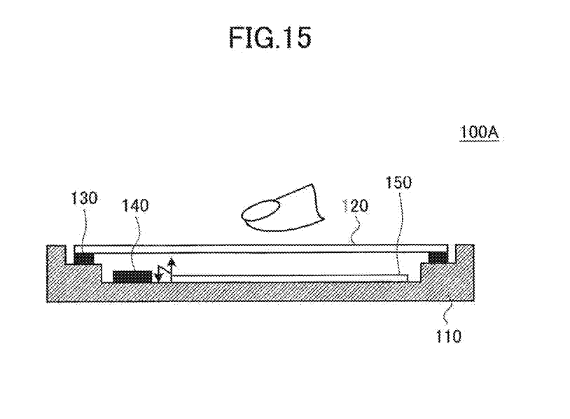

FIG. 15 illustrates an example of an electronic, device 100A in which the LRA 140 is provided in the case. In the electronic device 100A illustrated in FIGS. 10A through 10C, the LRA 140 is arranged near the substrate 150 provided inside the case 110.

The present embodiment is also applicable to the electronic device 100A. Furthermore, when the present embodiment is applied to the electronic device 100A, it is possible to express a clicking feeling when the button 2 of the metal dome type is pressed, similar to the case of the electronic device 100 according to the present embodiment.

### Second Embodiment

In the following, a description is given of a second embodiment with reference to drawings. In the second embodiment, the resonance frequency f0 of the LRA 140 is a value that is measured in a state v/here the LRA 140 is incorporated in the electronic device 100. In the description of the second embodiment, only the points that are different from the first embodiment are described. Furthermore, in the second embodiment, the elements having the same functions as those of the first embodiment are denoted by the same reference numerals and descriptions thereof are omitted.

In the present embodiment, a resonance frequency f0′ of the touch panel 120 is measured, in a state where the LRA 140 is incorporated in the electronic device 100. Furthermore, in the present embodiment, the resonance frequency f0′ is used when calculating the frequency f1 of the driving signals F.

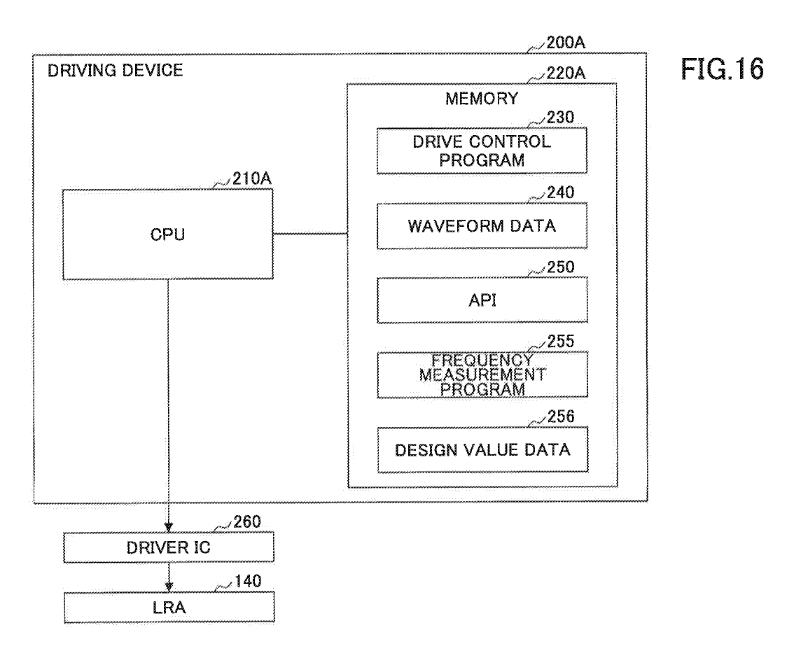

FIG. 16 illustrates a driving device 200A according to the second embodiment. The driving-device 200A according to the present embodiment includes a CPU 210A and a memory 220A.

The CPU 210A reads a frequency measurement, program 255 described below, from the memory 220A, and executes the frequency measurement program 255, to measure and reset the resonance frequency f0′ described below.

The memory 220A stores the drive control program 230, the waveform data 240, the API 250, and in addition, the frequency measurement program 255 and design value data 256.

For example, the frequency measurement program 255 causes the CPU 210A to execute a process of measuring the resonance frequency f0′ of the LRA 140 in a state where the LRA 140 is incorporated in the electronic device 100. The design value data 256 is a value that is determined when the electronic device 100 is designed. The design value data 256 according to the present embodiment is, for example, a resonance frequency f0 unique to the LRA 140.

In the following, a description is given of the measurement of the resonance frequency f0′ according to the present embodiment.

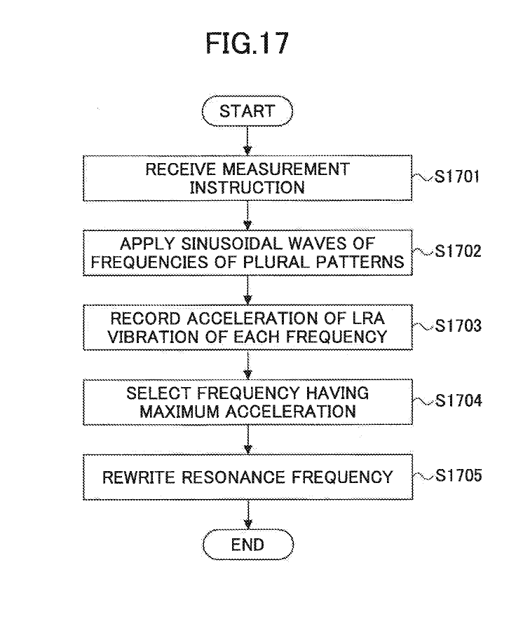

FIG. 17 is a flowchart of a process of measuring the resonance frequency according to the second embodiment.

In the present embodiment, when an instruction to measure the resonance frequency f0′ is given to the electronic device 100 (step S1701), the CPU 210A reads the frequency measurement program 255. In the present embodiment, an instruction to measure the resonance frequency f0′ is given, for example, when the process of incorporating the LRA 140 and the touch panel 120 in the case 110 is completed in the manufacturing process of the electronic device 100, or when the electronic device 100 is shipped from the factory.

The frequency measurement program 255 causes the CPU 210A to apply the sinusoidal waves of a plurality of frequencies in a band of predetermined frequencies, as driving signals to the LRA 140 (step S1702). Specifically, for example, the CPU 210A applies driving signals to the LRA 140, in the range 100 Hz through 300 Hz, as the sinusoidal wave of the frequency 100 Hz, the sinusoidal wave of the frequency 110 Hz, . . . , the sinusoidal wave of the frequency 290 Hz, and the sinusoidal wave of the frequency 300 Hz.

The frequency measurement program 255 causes the CPU 210A to store, in the memory 220A, the maximum value of the acceleration of the vibration of the touch panel 120 for each of the driving signals of different frequencies (step S1703). Specifically, the electronic device 100 has a built-in acceleration sensor (not illustrated), and every time the driving signals of different frequencies are applied to the LRA 140, the acceleration sensor detects the maximum value of the acceleration of the vibration of the touch panel 120. The memory 220A is provided with an area for storing the operation results by the frequency measurement program 255, and the maximum value of the acceleration of each of the driving signals is temporarily stored in this area.

Next, the frequency measurement program 255 causes the CPU 210A to select the frequency of the driving signals in which the acceleration is maximum, among the accelerations stored in the memory 220A (step S1704). Next, the frequency measurement program 255 sets the selected frequency of driving signals as the resonance frequency f0′, and causes the CPU 210A to overwrite the design value data 256 in the memory 220A with the resonance frequency f0′ (step S1705).

In the present embodiment, according to the above process, the resonance frequency is changed from f0 to f0′, Therefore, in the present embodiment, the frequency f1 of driving signals for suppressing the residual vibration becomes f1=m/n×f0′.

Thus, in the present embodiment, for example, when the vibrations of the touch panel 120 and the case 110 are superposed on the LRA 140, it is possible to calculate the driving signals f1 based on the resonance frequency f0′ of the touch panel 120 with which a contact of the user's finger is directly made. Thus, in the present, embodiment it is possible to directly provide the user with a tactile sensation of a waveform of a short time that rapidly attenuates in one through several cycles, and express a clicking feeling.

Note that in the present embodiment, the resonance frequency f0′ is measured by the frequency measurement program 255; however, it is possible to measure the resonance frequency f0′ outside the electronic device 100 and overwrite the design value data 256 in the memory 220A with the resonance frequency f0′ obtained outside the electronic device 100.

Furthermore, the present embodiment is also applicable to the electronic device 100A.

According to an aspect of the embodiments, a tactile sensation in accordance with an operation is provided.

The driving device, the electronic device, and the drive control program are not limited to the specific embodiments described herein, and variations and modifications may be made without departing from the scope of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit, and scope of the invention.

What is claimed is:

1. A driving device comprising:
a storage unit configured to store waveform data of driving signals of a sinusoidal wave satisfying a frequency f1=m/n×f0 (m, n are natural numbers, and m≠n) where a resonance frequency of an actuator is f0, wherein the driving signals excite the actuator for an m number of times; and
a processor programmed to execute a process including reading the waveform data stored in the storage unit and outputting, to the actuator, the driving signals corresponding to the waveform data that has been read.

2. The driving device according to claim 1, wherein
the frequency f1 satisfies f1=m/n×f0 (m, n are natural numbers, and m>n).

3. An electronic device comprising:
a touch panel;
an actuator configured to vibrate the touch panel, the actuator having a resonance frequency f0; and
a driving device including
a storage unit configured to store waveform data of driving signals of a sinusoidal wave satisfying a frequency f1=m/n×f0 (m, n are natural numbers, and m≠n) where a resonance frequency of the actuator is f0, wherein the driving signals excite the actuator for an m number of times, and
a processor programmed to execute a process including reading the waveform data stored in the storage unit and outputting, to the actuator, the driving signals corresponding to the waveform data that has been read.

4. The electronic device according to claim 3, wherein
the storage unit stores the resonance frequency f0 of the actuator, wherein
the process further includes
applying, on the actuator, the driving signals of different frequencies in a predetermined band,
storing, in the storage unit, a maximum value of an acceleration of a vibration of the touch panel of each of the driving signals, and
overwriting the resonance frequency f0 of the actuator stored in the storage unit, with a frequency of the driving signal corresponding to a maximum acceleration among the stored accelerations.

5. A non-transitory computer-readable recording medium storing a drive control program that causes a computer to execute a process, the process comprising:
reading waveform data of driving signals of a sinusoidal wave satisfying a frequency f1=m/n×f0 (m, n are natural numbers, and m≠n) where a resonance frequency of an actuator is f0, wherein the driving signals excite the actuator for an m number of times; and
outputting, to the actuator, the driving signals corresponding to the waveform data that has been read.

6. A drive control method executed by a computer, the method comprising:
reading, from a storage unit storing waveform data, the waveform data of driving signals of a sinusoidal wave satisfying a frequency f1=m/n+f0 (m, n are natural numbers, and m≠n) where a resonance frequency of an actuator is f0, wherein the driving signals excite the actuator for an m number of times; and
outputting, to the actuator, the driving signals corresponding to the waveform data that has been read.
